(19) United States
(12) Patent Application Publication
(10) Pub. No.: US 2022/0281101 A1
(43) Pub. Date: Sep. 8, 2022

(54) ARM REVOLVING-TYPE ROBOT

(71) Applicant: YAMAHA HATSUDOKI KABUSHIKI KAISHA, Iwata-shi, Shizuoka (JP)

(72) Inventor: Kenji ISHIZUKA, Shizuoka (JP)

(73) Assignee: YAMAHA HATSUDOKI KABUSHIKI KAISHA, Iwata-shi, Shizuoka (JP)

(21) Appl. No.: 17/637,738

(22) PCT Filed: Sep. 2, 2019
(86) PCT No.: PCT/JP2019/034444

§ 371 Date: Feb. 23, 2022

(51) Int. Cl. B25J 9/06

(52) U.S. Cl. CPC B25J 9/06

(57) ABSTRACT

An arm revolving-type robot includes a first member, and a second member coupled to the first member so as to be relatively rotatable, at least one of the first member and the second member including an arm portion. The second member includes a member main body portion, a protrusion that is provided on the member main body portion so as to protrude outward from a wall surface of the member main body portion, and that abuts on the first member along with rotation of the second member to regulate a rotation range of the second member, and a shaft-shaped reinforcing member disposed inside the protrusion. The protrusion and a remaining portion of the member main body portion are integrally formed of the same material, and the reinforcing member is disposed from the protrusion to the remaining portion of the member main body portion.

### CROSS-REFERENCE TO RELATED APPLICATION

This application is a National Stage of International Patent Application No. PCT/JP2019/034444, filed Sep. 2, 2019, the entire content of which is incorporated herein by reference.

### BACKGROUND

### Technical Field

The present disclosure relates to an arm revolving-type robot having a revolvable arm.

### Background Art

Conventionally, an arm revolving-type robot having a revolvable arm is known. For example, an articulated robot such as a horizontal articulated robot or a vertical articulated robot can be said to be a representative example of an arm revolving-type robot.

In an arm revolving-type robot, it is a common practice that a revolving angle of the arm is limited within a predetermined range by a program, and that a stopper for forcibly (mechanically) preventing the arm from revolving beyond the predetermined range is provided on the assumption that a malfunction occurs.

For example, JP 2013-6241 A discloses an example of a horizontal articulated robot including a stopper. The horizontal articulated robot includes a base fixed on a base platform, and an arm (robot arm) revolvably supported by the base. The arm is configured with a first arm portion revolvably supported by the base, and a second arm portion revolvably coupled to a distal end of the first arm portion. As the stopper, a pair of first protrusions is provided on an upper surface of the first arm portion, and a second protrusion is provided on a lower surface of the second arm portion. The first and second protrusions are disposed on the same circumference about a coupling shaft (rotation shaft) between the first arm portion and the second arm portion. In other words, a revolving angle of the second arm portion with respect to the first arm portion is regulated within a predetermined range as a result of abutting of the first and second protrusions on each other.

In the horizontal articulated robot, the first and second arm portions are cast parts, and the first and second protrusions are molded integrally with the first and second arm portions. Therefore, the following problem is considered. Specifically, in a recent articulated robot, reduction in arm weight is intended by configuring the arm with an aluminum alloy (aluminum die-casting) in order to revolve the arm at a higher speed. In this configuration, when a collision load is large at the time of collision between the first protrusion and the second protrusion, the protrusion might break and fall off.

### SUMMARY

The present disclosure has been made in view of the above circumstances, and provides a technique enabling, in an arm revolving-type robot in which a protrusion is integrally molded with an arm portion as a stopper, damage of a protrusion to be effectively suppressed.

Then, the present disclosure is an arm revolving-type robot including a first member, and a second member coupled to the first member so as to be relatively rotatable. At least one of the first member and the second member includes an arm portion, in which the second member includes a member main body portion, a protrusion that is provided on the member main body portion so as to protrude outward from a wall surface of the member main body portion and that abuts on the first member along with rotation of the second member to regulate a rotation range of the second member, and a shaft-shaped reinforcing member disposed inside the protrusion. The protrusion and a remaining portion of the member main body portion are integrally formed of the same material, and the reinforcing member is disposed from the protrusion to the remaining portion of the member main body portion.

### BRIEF DESCRIPTION OF THE DRAWINGS

FIG. 1 is a side view of a horizontal articulated robot to which the present disclosure is applied;

FIG. 2 is a perspective view of the horizontal articulated robot as viewed obliquely from below;

FIG. 3 is a cross-sectional view of a part of an arm main body portion showing a structure of a first protrusion (second protrusion);

FIG. 4 is an explanatory view for describing a rotation range of a first arm portion;

FIG. 5 is an explanatory view for describing a rotation range of a second arm portion;

FIG. 6 is a cross-sectional view of a part of an arm main body portion showing a structure of a first protrusion (second protrusion) according to a modification;

FIG. 7 is a cross-sectional view of a part of the arm main body portion showing the structure of the first protrusion (second protrusion) according to the modification;

FIG. 8 is a cross-sectional view of a part of the arm main body portion showing the structure of the first protrusion (second protrusion) according to the modification; and

FIG. 9 is a cross-sectional view of a part of the arm main body portion showing the structure of the first protrusion (second protrusion) according to the modification.

### DETAILED DESCRIPTION

Hereinafter, embodiments of the present disclosure will be described with reference to the drawings.

[Overall Configuration of Robot]

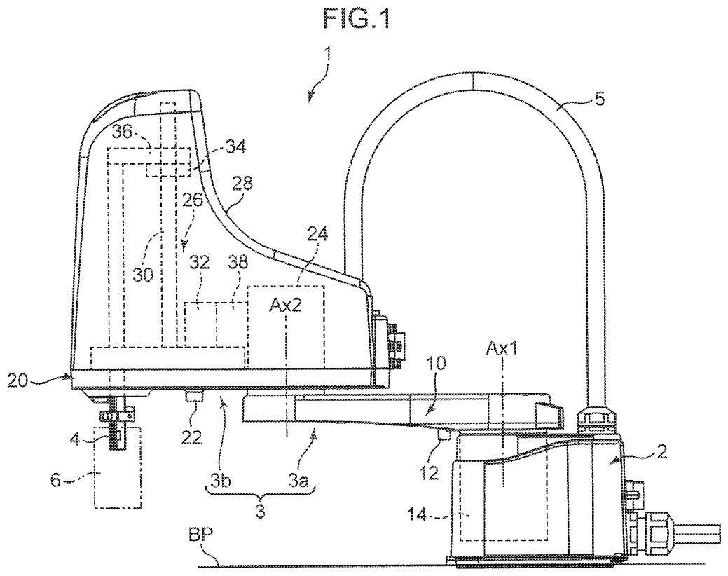

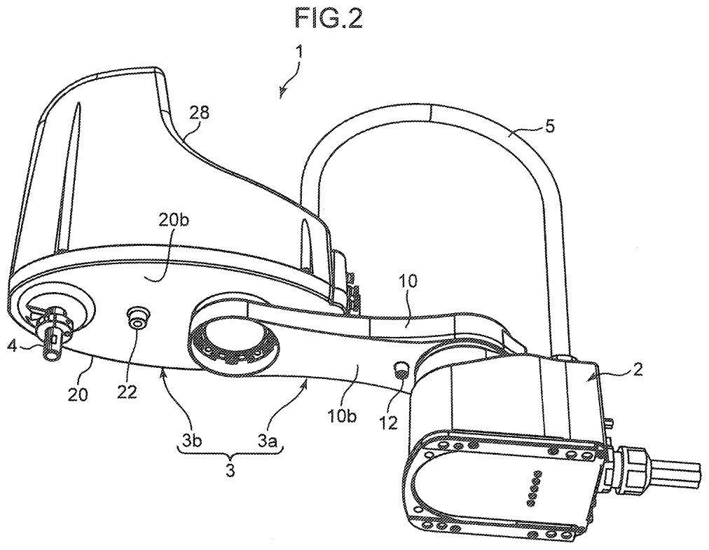

FIG. 1 is a side view of a horizontal articulated robot (scalar robot) which is an arm revolving-type robot according to the present disclosure, and FIG. 2 is a perspective view of the horizontal articulated robot as viewed obliquely from below.

A horizontal articulated robot (hereinafter, abbreviated as robot) 1 illustrated in FIG. 1 and FIG. 2 has an arm support base 2 having a substantially columnar shape and installed on a base platform BP, an arm 3 coupled to the arm support base 2, and a work shaft 4 supported at a distal end portion of the arm 3.

Note that the reference numeral 5 in FIG. 1 denotes a tubular guide member in which there are accommodated a cable for transmitting power and a control signal to motors 24, 32, 38 etc. to be described later that are mounted on the arm 3, and the like, the tubular guide member being provided to have an arch shape over the arm support base 2 and the arm 3 (a second arm portion 3b to be described later).

The arm 3 includes a first arm portion 3a supported by the arm support base 2 and extending in a horizontal direction, and a second arm portion 3b supported at a distal end of the first arm portion 3a and extending in the horizontal direction.

The first arm portion 3a has a plate-shaped arm main body portion 10 having a thickness in an up-down direction. The arm main body portion 10 corresponds to a frame member of the first arm portion 3a and is made of a die-cast aluminum alloy.

The arm main body portion 10 (the first arm portion 3a) is supported above the arm support base 2 so as to be rotatable (revolvable) about a vertical axis Ax1. The arm main body portion 10 (the first arm portion 3a) is coupled to a first arm motor 14 disposed inside the arm support base 2 via a speed reduction mechanism (not illustrated), and is rotationally driven by the first arm motor 14.

The second arm portion 3b has a plate-shaped arm main body portion 20 having a thickness in the up-down direction, a second arm motor 24, a drive mechanism portion 26 of the work shaft 4, and a cover member 28.

The arm main body portion 20 corresponds to a frame member of the second arm portion 3b, and is made of a die-cast aluminum alloy similarly to the arm main body portion 10 of the first arm portion 3a.

The arm main body portion 20 is supported above the distal end of the first arm portion 3a (the arm main body portion 10) so as to be rotatable (revolvable) about a vertical axis Ax2. The second arm portion 3b is coupled to a main body portion of the second arm motor 24 mounted on the second arm portion 3b and coupled to the first arm portion 3a via a speed reduction mechanism (not illustrated), and is rotationally driven by the second arm motor 24.

The work shaft 4 is a spline shaft. The work shaft 4 is supported at a distal end portion of the arm main body portion 20 so as to move in the up-down direction (axially) and rotate about the axis with respect to the arm main body portion 20 while vertically penetrating the arm main body portion 20 in the up-down direction.

The drive mechanism portion 26 includes an up-down movement mechanism 26a for moving the work shaft 4 in the up-down direction, and a rotation drive mechanism for rotating the work shaft 4.

The up-down movement mechanism includes a screw shaft 30 disposed in parallel with the work shaft 4 and rotatably supported by the arm main body portion 20, a Z-axis motor 32 that rotatably drives the screw shaft 30, a nut member 34 attached to the screw shaft 30, and a coupling member 36 that couples an upper end portion of the work shaft 4 and the nut member 34. Specifically, the up-down movement mechanism causes the screw shaft 30 to rotate by driving the Z-axis motor 32, converts the rotational movement of the screw shaft 30 into up-down movement of the work shaft 4 via the nut member 34 and the coupling member 36, and causes the work shaft 4 to move in the up-down direction.

On the other hand, the rotation drive mechanism includes an R-axis motor 38, and a belt transmission mechanism that transmits a rotational force of the R-axis motor 38 to the work shaft 4, and causes the work shaft 4 to rotate by driving the R-axis motor 38.

A work tool (not illustrated) is attached to a distal end portion of the work shaft 4. A work tool 6 for performing predetermined work on a workpiece is attached to a distal end portion of the work shaft 4, the work tool such as a chuck device for holding and conveying a workpiece, a machining device for performing various machining such as welding on a workpiece, and a measuring device for measuring a workpiece. The type of the work tool 6 is, however, not limited to the chuck device, the machining device, and the measurement device. In this example, the work shaft 4, the work tool 6, and the drive mechanism portion 26 correspond to a “work mechanism portion” of the present disclosure.

The cover member 28 made of resin is attached to the arm main body portion 20 of the second arm portion 3b. The cover member 28 has a substantially dome shape, and the drive mechanism portion 26 disposed on the arm main body portion 20 and the work shaft 4 (a portion protruding upward of the arm main body portion 20) are covered with the cover member 28.

As will be described later, the first arm portion 3a of the arm 3 includes a first protrusion 12 that regulates a rotation range of the first arm portion 3a. Therefore, in this example, the arm support base 2 and the first arm portion 3a correspond to a “first member” and a “second member” of the present disclosure, respectively. Also as will be described later, the second arm portion 3b of the arm 3 also includes a second protrusion 22 that regulates a rotation range of the second arm portion 3b. Therefore, in this example, it can be said that the first arm portion 3a and the second arm portion 3b correspond to the “first member” and the “second member” of the present disclosure, respectively. Each of the arm main body portions 10 and 20 correspond to a “member main body portion” of the present disclosure.

[Structure for Regulating Rotation Range of Arm 3]

In the robot 1, the arm motors 14 and 24 are driven and controlled by a controller (not illustrated) so as to move the arm 3 within a predetermined range on a horizontal plane. Assuming a case where malfunction occurs, stoppers for forcibly (mechanically) preventing revolving beyond the predetermined range are provided on the first arm portion 3a and the second arm portion 3b.

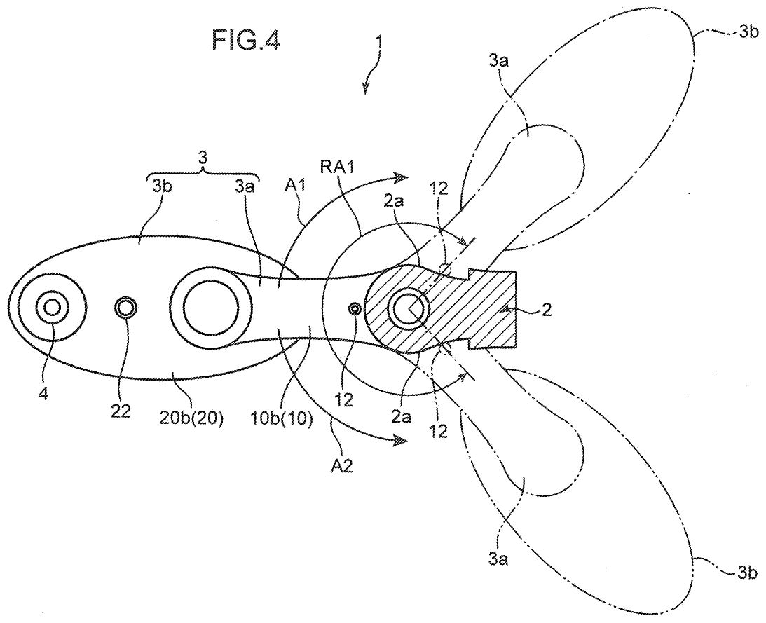

Specifically, as illustrated in FIG. 1 and FIG. 2, the first arm portion 3a is provided, as a stopper, with the first protrusion 12 on a lower surface of the arm main body portion 10. As illustrated in FIG. 4, the first protrusion 12 abuts on a side surface 2a of the arm support base 2 along with the rotation of the first arm portion 3a in an arrow A1 direction or in an arrow A2 direction, thereby regulating further rotation of the first arm portion 3a. With this configuration, the rotation range (revolving angle range) of the first arm portion 3a with respect to the arm support base 2 is limited within a range RA1 illustrated in FIG. 4. Note that the first protrusion 12 is provided at a proximal end portion in a longitudinal direction (a left-right direction in FIG. 1) of the arm main body portion 10 and at a central portion in a width direction (a direction orthogonal to the paper surface in FIG. 1) thereof.

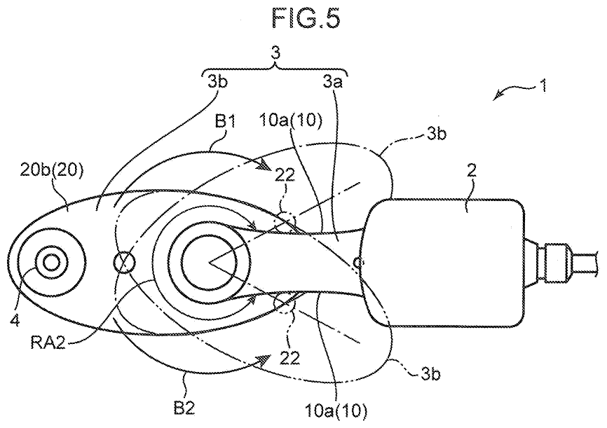

The second arm portion 3b is similarly provided with, as a stopper, the second protrusion 22 on a lower surface of the arm main body portion 20. As illustrated in FIG. 5, the second protrusion 22 abuts on a side surface 10a of the arm main body portion 10 of the first arm portion 3a along with the rotation of the second arm portion 3b in an arrow B1 direction or an arrow B2 direction, thereby regulating further rotation of the second arm portion 3b. With this configuration, the rotation range (revolving angle range) of the second arm portion 3b with respect to the first arm portion 3a is limited within a range RA2 illustrated in FIG. 5. Note that the second protrusion 22 is provided at a central portion in the longitudinal direction of the arm main body portion 20 and at a central portion in a width direction thereof.

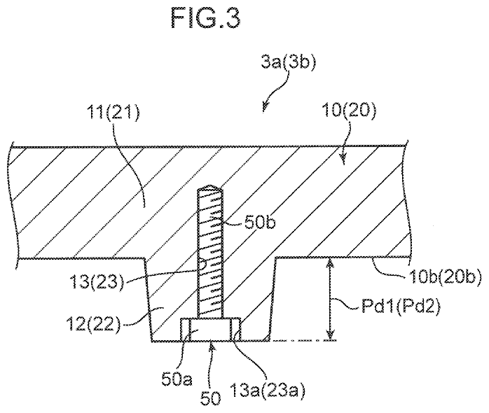

FIG. 3 illustrates a cross-sectional structure of the first protrusion 12. In this example, since the structure of the second protrusion 22 is basically common to the structure of the first protrusion 12, reference signs indicating the structure of the second protrusion 22 are shown in parentheses in FIG. 3.

The first protrusion 12 is provided integrally with the arm main body portion 10 so as to protrude downward from a lower surface 10b of the arm main body portion 10 of the first arm portion 3a by a predetermined dimension Pd1. In other words, in the arm main body portion 10, the first protrusion 12 and a remaining portion 11, i.e., a plate-shaped portion other than the first protrusion 12, are integrally molded using the same material (aluminum alloy).

The first protrusion 12 is a truncated cone-shaped protrusion, and has a bolt 50 (corresponding to a “shaft-shaped reinforcing member” of the present disclosure) disposed at the center thereof, the bolt including a head portion 50a and a screw shaft portion 50b. Specifically, in the first protrusion 12, a screw hole 13 is formed along a center line of the first protrusion 12 from the first protrusion 12 to the remaining portion 11 of the arm main body portion 10, and the bolt 50 is screwed and inserted into the screw hole 13. As a result, the bolt 50 is disposed from the first protrusion 12 to the remaining portion 11 of the arm main body portion 10. In other words, the bolt 50 is disposed so as to penetrate a boundary surface between the first protrusion 12 and the remaining portion 11 of the arm main body portion 10 (a virtual surface obtained by extending the lower surface 10b of the arm main body portion 10 to the position of the first protrusion 12).

In this example, the bolt 50 is a hexagonal hole bolt made of a material having a shear strength higher than that of an aluminum alloy which is a material of the arm main body portion 10, such as alloy steel or stainless steel.

The screw hole 13 has a counterbore portion 13a (a portion obtained by cutting off an inlet portion of the screw hole 13 one step deeper so as to have a larger diameter), and the bolt 50 is screwed and inserted into the screw hole 13 in a state where the head portion 50a thereof is accommodated in the counterbore portion 13a. As a result, the bolt 50 is disposed within the first protrusion 12 without causing the head portion 50a to protrude outward (downward) from the first protrusion 12.

As described above, the structure of the second protrusion 22 is also common to that of the first protrusion 12. Specifically, the second protrusion 22 is integrally provided with the arm main body portion 20 so as to protrude downward from a lower surface 20b of the arm main body portion 20 of the second arm portion 3b by a predetermined dimension Pd2. The second protrusion 22 is a truncated cone-shaped protrusion. A screw hole 23 having a counterbore portion 23a is formed at the center of the second protrusion 22, and a bolt 50 made of a hexagonal hole bolt is screwed and inserted into the screw hole 23. As a result, the bolt 50 is disposed from the second protrusion 22 to a remaining portion 21 of the arm main body portion 20.

[Operational Effects]

According to the robot 1 described above, the first protrusion 12 of the first arm portion 3a abuts on the side surface 2a of the arm support base 2, whereby the rotation range of the first arm portion 3a with respect to the arm support base 2 is regulated. In addition, the second protrusion 22 of the second arm portion 3b abuts on the side surface 10a of the first arm portion 3a (the arm main body portion 10), whereby the rotation range of the second arm portion 3b with respect to the first arm portion 3a is regulated. Therefore, the arm portions 3a and 3b are prevented from rotating beyond the rotation range due to the malfunction, and collision between the arm 3 and a tubular guide member 5 and disconnection of the cable or the like due to the collision are reliably prevented.

In this case, since the bolt 50 is provided inside each of the first protrusion 12 and the second protrusion 22 to reinforce the first protrusion 12 and the second protrusion 22, respectively, the strength of each of the protrusions 12 and 22 is larger than that in a case where the bolt 50 is not provided. Specifically, the bolt 50 has a large shear strength. Therefore, it is possible to effectively suppress occurrence of a situation in which the first protrusion 12 breaks and falls off upon reception of a shear load when the first protrusion 12 abuts on the side surface 2a of the arm support base 2, or a situation in which the second protrusion 22 breaks and falls off upon reception of a shear load when the second protrusion 22 abuts on the side surface 10a of the first arm portion 3a (the arm main body portion 10).

Moreover, in the robot 1, as described above, the bolt 50 made of an existing hexagonal hole bolt is screwed and inserted into each of the protrusions 12 and 22, whereby the shear strength of each of the protrusions 12 and 22 is increased. Therefore, according to the configuration of the robot 1, there is provided an advantage that damage of the protrusions 12 and 22 can be suppressed with a simple and inexpensive configuration. In addition, even for a robot already used in a factory line or the like, that is, an existing robot including only a protrusion corresponding to each protrusion 12, 22 as a stopper but not including the bolt 50, forming a screw hole in the protrusion and screwing and inserting a bolt into the screw hole enables a configuration equivalent to that of the robot 1 to be retrofitted. Accordingly, the existing robot can also enjoy the same operational effects as those of the robot 1 described above.

Moreover, according to the robot 1, the head portion 50a of the bolt 50 is accommodated in the counterbore portion 13a, 23a, and the head portion 50a does not protrude to the outside from each protrusion 12, 22. Therefore, it is possible to in advance avoid a possible trouble occurring when the head portion 50a of the bolt 50 is assumed to be exposed to the outside from the protrusion 12, 22, for example, a trouble that the head portion 50a unintentionally comes into contact with a peripheral equipment or the arm support base 2 (the first arm portion 3a) and breaks or falls off.

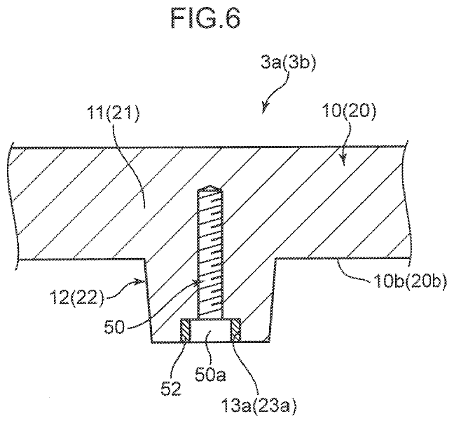

In this case, as shown in FIG. 6, a cylindrical buffer member 52 made of metal or resin may be fitted between an inner peripheral surface of the counterbore portion 13a and an outer peripheral surface of the head portion 50a to fill these gaps. According to this configuration, since a collision load when each protrusion 12, 22 abuts on the opponent member (the arm support base 2 or the first arm portion 3a) is transmitted to the head portion 50a of the bolt 50 via the buffer member 52, the damage of each protrusion 12, 22 is more effectively suppressed. In other words, in a case where the buffer member 52 is not provided, since displacement of each protrusion 12, 22 is allowed by the gap upon reception of the collision load, stress might concentrate on a distal end portion of each protrusion 12, 22 due to the displacement, resulting in causing a crack and damage. In this regard, according to the configuration illustrated in FIG. 6, since the gap is eliminated by the buffer member 52, the above-described damage of each protrusion 12, 22 caused by the gap is effectively suppressed. In particular, since in a case where the buffer member 52 is made of metal, the protrusion 12, 22 is reinforced also by the buffer member 52, damage of each protrusion 12, 22 is more effectively suppressed.

Furthermore, according to the robot 1 as described above, there is also provided an advantage that strength (shear strength) of each protrusion 12, 22 of the arm 3 can be easily increased as necessary. For example, due to a specification change (design change), there occurs a case where each arm motor 14, 24 is changed to a higher-output one in order to drive the arm 3 at a higher speed (high torque). In such a case, there might occur a case where the strength (shear strength) of each protrusion 12, 22 needs to be increased. In such a case, according to the robot 1, the strength (shear strength) of each protrusion 12, 22 can be increased by relatively simple additional steps by increasing the size of the bolt 50 according to a procedure of 1) removing the bolt 50, 2) enlarging the screw hole 13 of each protrusion 12, 22 with a drill to form a prepared hole, 3) recutting the prepared hole with a tap to form the screw hole 13 increased in size, and 4) screwing and inserting the bolt 50 increased in size into the screw hole 13. Therefore, even when a specification change (design change) occurs as described above, it is possible to effectively use the existing arm 3 (each arm portion 3a, 3b) stored as a stock without discarding the arm or the like.

[Modification Etc.]

The robot 1 described above is an example of a preferred embodiment of the arm revolving-type robot according to the present disclosure, and the specific configuration of the robot 1 can be appropriately changed without departing from the gist of the present disclosure. For example, the following configuration can be also adopted.

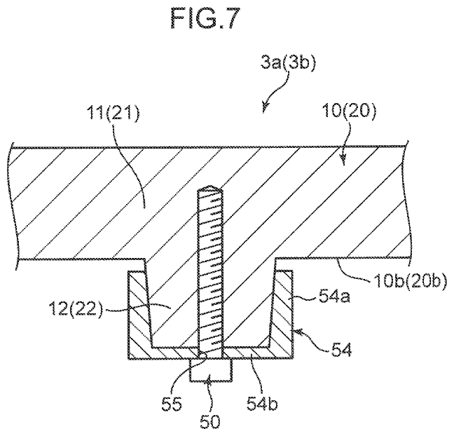

(1) As shown in FIG. 7, the robot 1 may further include an impact-absorbing member 54 that absorbs impact at the time of abutting between each protrusion 12, 22 and a counterpart member (the arm support base 2 or the first arm portion 3a). The impact-absorbing member 54 is a cup-shaped member having a peripheral wall portion 54a and a bottom wall portion 54b that are in close contact with a distal end surface and an outer peripheral surface of each of the protrusions 12 and 22, respectively, and is integrally formed of rubber or a resin material as a whole. As illustrated in FIG. 7, the impact-absorbing member 54 covers the protrusions 12 and 22 from below. Then, the bolt 50 is screwed and inserted into the screw hole 13 through an opening portion 55 formed in the bottom wall portion 54b, so that the impact-absorbing member 54 is fixed to each of the protrusions 12 and 22 by the bolt 50. In this configuration, the counterbore portion 13a as illustrated in FIG. 3 and FIG. 6 is not provided in the screw hole 13.

According to the structure illustrated in FIG. 7, an impact force applied to each of the protrusions 12 and 22 at the time of abutting between each of the protrusions 12 and 22 and its counterpart member (the arm support base 2 or the first arm portion 3a) is mitigated. Therefore, damage of the protrusions 12 and 22 is more highly suppressed. Moreover, there is also provided an advantage that a reasonable configuration can be achieved in which the bolt 50, which is a reinforcing member of each protrusion 12, 22, is used also as a member for attaching the impact-absorbing member 54 to each protrusion 12, 22.

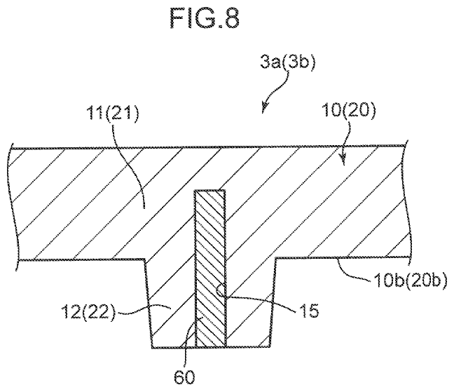

(2) Although in the embodiment, the bolt 50 (hexagonal hole bolt) is applied as the “shaft-shaped reinforcing member” of the present disclosure, the “shaft-shaped reinforcing member” is not limited thereto. For example, the “shaft-shaped reinforcing member” may be a pin (cylindrical body) 60 as shown in FIG. 8. In this case, as shown in FIG. 8, the pin 60 may be press-fitted into a pin hole 15 formed along the center line of each protrusion 12, 22, or may be inserted into the pin hole 15 and then bonded (brazed) to each protrusion 12, 22. Note that the pin 60 is preferably made of a material, such as stainless steel, having a higher shear strength than the aluminum alloy which is the material of the arm main body portions 10 and 20.

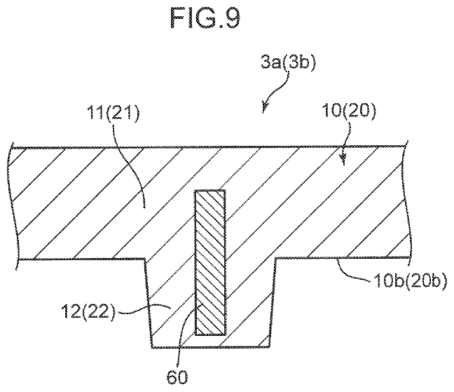

In addition to being press-fitted into the pin hole 15 as described above, the pin 60 may be embedded inside the arm main body portion 10, 20 by, for example, insert-molding as illustrated in FIG. 9.

(3) Although in the embodiment, both the arm main body portion 10 of the first arm portion 3a and the arm main body portion 20 of the second arm portion 3b are made of a die-cast aluminum alloy, of course, both may be made of a metal material other than the die-cast aluminum alloy. In addition to a metal material, a resin material may be used.

(4) Although in the embodiment, the description has been made of the example in which the present disclosure is applied to a horizontal articulated robot as the “arm revolving-type robot” of the present disclosure, the present disclosure is not limited thereto. The present disclosure is also applied to an articulated robot other than a horizontal articulated robot, for example, to a vertical articulated robot. In addition, the present application is also applicable to any arm revolving-type robot, other than an articulated robot, that includes a first member and a second member coupled to the first member so as to be relatively rotatable, at least one of the first member and the second member including an arm portion.

### CONCLUSION OF DISCLOSURE

The present disclosure described above is summarized as follows.

An arm revolving-type robot according to one aspect of the present disclosure is an arm revolving-type robot including a first member, and a second member coupled to the first member so as to be relatively rotatable, at least one of the first member and the second member including an arm portion, in which the second member includes a member main body portion, a protrusion that is provided on the member main body portion so as to protrude outward from a wall surface of the member main body portion and that abuts on the first member along with rotation of the second member to regulate a rotation range of the second member, and a shaft-shaped reinforcing member disposed inside the protrusion, the protrusion and a remaining portion of the member main body portion are integrally formed of the same material, and the reinforcing member is disposed from the protrusion to the remaining portion of the member main body portion.

According to the arm revolving-type robot, since the shaft-shaped reinforcing member is disposed from the protrusion to the remaining portion of the member main body portion, the strength of the protrusion, specifically, the shear strength is increased as compared with a case where no reinforcing member is provided. Therefore, it is possible to suppress damage (falling off) of the protrusion when the protrusion abuts on the first member along with the rotation of the second member.

In the above configuration, it is preferable that the reinforcing member is a bolt including a head portion and a screw shaft portion, and is screwed and inserted into the member main body portion, resulting in being disposed from the protrusion to the remaining portion.

According to this configuration, since a bolt which is a general-purpose product is applied as the reinforcing member, it is possible to enjoy the above-described operational effects while suppressing product costs and manufacturing costs. In addition, since this configuration is a simple configuration in which a screw hole is formed in the second member and a bolt is screwed and inserted into the screw hole, it is possible to apply the configuration to an arm revolving-type robot already used in a factory line or the like later by retrofitting.

In this case, it is preferable that the member main body portion includes a screw hole having a counterbore portion and extending from the protrusion to the remaining portion, and the bolt is screwed and inserted into the screw hole in a state where a head portion of the bolt is accommodated in the counterbore portion.

According to this configuration, since the head portion is disposed in the counterbore portion, the bolt (head portion) is suppressed from protruding from the protrusion to the outside, and thus, the head portion of the bolt is suppressed from unintentionally coming into contact with a peripheral equipment or the first member and being damaged as in a case where the entire head portion of the bolt is exposed from the protrusion to the outside.

Furthermore, in this case, it is preferable to further include a buffer member interposed between an inner peripheral surface of the counterbore portion and an outer peripheral surface of the head portion to fill a gap between the inner peripheral surface and the outer peripheral surface.

According to this configuration, it is possible to more effectively suppress damage of the protrusion. Specifically, in a case where no buffer member is provided, since displacement of the protrusion is allowed by the gap upon reception of a collision load at the time of abutting between the protrusion and the first member, a crack might occur in a distal end portion of the protrusion due to the displacement. In this regard, according to the configuration including the buffer member, since the gap is eliminated by the buffer member, damage of the protrusion caused by the gap is suppressed.

In addition, in the arm revolving-type robot of an aspect in which a bolt is applied as the reinforcing member, it is preferable to further include an impact-absorbing member that is fixed to the protrusion by the bolt and absorbs an impact force at the time of abutting between the protrusion and the first member.

According to this configuration, an impact force applied to the protrusion at the time of abutting between the protrusion and the first member is mitigated. Therefore, it is possible to more effectively suppress damage of the protrusion. Moreover, a reasonable configuration can be achieved in which the bolt serving as the reinforcing member is used also as a member for attaching the impact-absorbing member to the protrusion.

Note that, in a case where the second member includes a work mechanism portion for performing predetermined work on a workpiece, when the second member rotates with respect to the first member beyond a range set on a program, serious damage might be given to the workpiece, a peripheral device, and the robot (the arm revolving-type robot) itself, and it is thus necessary to more reliably suppress occurrence of such a situation.

Therefore, the configuration of the arm revolving-type robot of each aspect described above is particularly useful in a case where the second member includes a work mechanism for performing predetermined work on a workpiece.

1. An arm revolving-type robot comprising:
a first member, and
a second member coupled to the first member so as to be relatively rotatable, at least one of the first member and the second member including an arm portion, wherein
the second member includes a member main body portion, a protrusion that is provided on the member main body portion so as to protrude outward from a wall surface of the member main body portion and that abuts on the first member along with rotation of the second member to regulate a rotation range of the second member, and a shaft-shaped reinforcing member disposed inside the protrusion,
the protrusion and a remaining portion of the member main body portion are integrally formed of the same material, and
the reinforcing member is disposed from the protrusion to the remaining portion of the member main body portion.

2. The arm revolving-type robot according to claim 1, wherein the reinforcing member is a bolt including a head portion and a screw shaft portion, and is screwed and inserted into the member main body portion, resulting in being disposed from the protrusion to the remaining portion.

3. The arm revolving-type robot according to claim 2, wherein
the member main body portion includes a screw hole having a counterbore portion and extending from the protrusion to the remaining portion, and
the bolt is screwed and inserted into the screw hole in a state where a head portion of the bolt is accommodated in the counterbore portion.

4. The arm revolving-type robot according to claim 3, further comprising:
a buffer member interposed between an inner peripheral surface of the counterbore portion and an outer peripheral surface of the head portion to fill a gap between the inner peripheral surface and the outer peripheral surface.

5. The arm revolving-type robot according to claim 2, further comprising:
an impact-absorbing member that is fixed to the protrusion by the bolt and absorbs an impact force at the time of abutting between the protrusion and the first member.

6. The arm revolving-type robot according to claim 1, wherein the second member includes a work mechanism portion for performing predetermined work on a workpiece.

7. The arm revolving-type robot according to claim 2, wherein the second member includes a work mechanism portion for performing predetermined work on a workpiece.

8. The arm revolving-type robot according to claim 3, wherein the second member includes a work mechanism portion for performing predetermined work on a workpiece.

9. The arm revolving-type robot according to claim 4, wherein the second member includes a work mechanism portion for performing predetermined work on a workpiece.

10. The arm revolving-type robot according to claim 5, wherein the second member includes a work mechanism portion for performing predetermined work on a workpiece.
